(19) United States
(12) Patent Application Publication
(10) Pub. No.: US 2011/0273166 A1
(43) Pub. Date: Nov. 10, 2011

(54) MAGNETIC ENCODER SCALE

(75) Inventors: Howard T. Salt, Algonquin, IL (US); Geoffrey Mcfarland, Wickwar (GB); Janez Novak, Ljubljana (SI); Ljubo Slabajna, Kamnik (SI)

(73) Assignees: RLS MERILNA TEHNIKA D.O.O., LJUBLJANA, DOBRUNJE (SI); RENISHAW PLC, WOTTON-UNDER-EDGE, GLOUCESTERSHIRE (GB)

(21) Appl. No.: 13/145,258

(22) PCT Filed: Jan. 19, 2010
(86) PCT No.: PCT/GB10/00066

§ 371 Date: Jul. 19, 2011

Related U.S. Application Data
(60) Provisional application No. 61/202,074, filed on Jan. 27, 2009.

(51) Int. Cl. G01B 7/14; B05D 1/38; B05D 3/12; C23F 1/02; B05D 5/00

(52) U.S. Cl. 324/207.24; 216/22; 427/127

(57) ABSTRACT

An encoder scale is a piston rod for use in a pneumatic or hydraulic cylinder. The method includes the steps of providing a mask defining a required groove pattern on an encoder scale member that is formed from a first material (e.g. steel) and etching material from the encoder scale member, through the mask, to form a plurality of grooves in the outer surface of the encoder scale member. A second material such as copper is then deposited on to the encoder scale member to substantially fill the grooves, the second material having a different magnetic permeability than the first material. A machining process (e.g. grinding) is then used to remove any excess second material and thereby provide an encoder scale member having a substantially smooth outer surface. A step of coating the outer surface of the encoder scale member with a metal, such as chronium, is then performed.

The present invention relates to magnetic encoder scales and in particular to a method of forming piston rods having a series of magnetic scale markings that permit the longitudinal position of the piston rod within its casing to be measured.

Hydraulic and pneumatic cylinders are known and are widely used in many heavy duty mechanical applications. A typical hydraulic cylinder comprises a casing defining a pressurised cylinder and a piston rod that is slidable within that casing. A fluid seal between the piston rod and the aperture in the casing through which the piston rod extends is provided to prevent the leakage of the pressurised hydraulic fluid. Any damage to the surface of the piston rod can compromise the fluidic seal and thus result in leakage of hydraulic fluid.

In many applications it is desirable to incorporate a measurement system into the hydraulic cylinder that allows the position of the piston rod relative to the casing to be measured. Any such measurement system must be highly robust as it is often required to operate in a harsh and dirty environment in which it is subjected to relatively high mechanical forces and shocks. Hydraulic cylinders that incorporate magnetic encoders have thus been proposed previously in which a magnetic transducer attached to the cylinder casing reads a magnetic scale pattern formed along the piston rod. Examples of known hydraulic cylinders are described in US2004/155800, GB2096421 and US2007/0214952

US2004/155800 describes a hydraulic cylinder in which multiple Hall sensor elements scan a piston rod that comprises an embedded, passive, magnetic scale. The piston rod comprises a steel core having a series of circumferential grooves formed therein. A protective outer ceramic coating is provided on the piston rod to fill the grooves. The ceramic coating is ground and polished to provide a smooth outer rod surface that provides the necessary fluidic seal with the casing of the hydraulic cylinder.

GB2096421 describes a hydraulic cylinder or ram comprising a piston rod having multiple side-by-side coded tracks along its length. The tracks encode a binary pattern that allows the absolute position of the piston rod relative to the casing to be established. In one embodiment, a passive magnetic scale is formed by photo-etching parts of the surface of a steel rod to form the required scale pattern. A chromium layer is then applied over the steel rod and a surface grinding process is used to grind away undulations in the chromium to provide the required smooth surface finish.

US2007/0214952 describes the formation of a piston rod having an outer coating of chromium. In particular, US2007/0214952 describes grinding a sinusoidally varying surface profile into the surface of a ferromagnetic rod. Layer(s) of non-magnetic material are deposited onto the surface of the steel rod and a surface grinding process is used to provide a smooth outer chromium coating.

According to a first aspect of the invention, a method of making an encoder scale comprises the steps of:
(a) providing a mask defining a required groove pattern on an encoder scale member that is formed from a first material,
(b) etching material from the encoder scale member, through the mask, to form a plurality of grooves in the outer surface of the encoder scale member,
(c) depositing a second material on to the encoder scale member to substantially fill the grooves, the second material having a different magnetic permeability than the first material,
(d) using a machining process to remove any excess second material and thereby provide an encoder scale member having a substantially smooth outer surface, and
(e) coating the outer surface of the encoder scale member with a metal.

The present invention thus provides an improved method of making an encoder scale (such as a piston rod) in which a passive magnetic scale track is embedded.

The method comprises using a mask formed on a (blank) encoder scale member to define a groove pattern that is then etched into the encoder scale member. The encoder scale member comprises a first (e.g. magnetic) material and the grooves formed therein are filled with a second (e.g. non-magnetic) material thus providing an encoder scale member having regions of varying magnetic properties. This second material is machined (e.g. ground or broached back to the level of the blank encoder scale member surface) to provide a smooth surface before the deposition of an outer layer of metal.

The outer layer of metal provided in step (e) is preferably hard and non-magnetic. Advantageously, the metal comprises chromium, or a similar metal, which is significantly more robust and damage resistant than ceramic layers of the type described in US2004/155800 that can become chipped or cracked in use. If the invention is applied to forming an encoder scale in the form of a piston rod, the increased robustness of the outer metal surface has the advantage of greatly reducing the risk of the fluid seal between the piston rod and associated cylinder casing failing during use.

Although hard metals, such as chromium and the like, are ideal as the outer protective coating on a piston rod to be operated in a harsh environment, the hardness of chromium also means that it is difficult and expensive to machine such material. There can also be practical difficulties associated with depositing thick and uniform chromium layers. The method of the present invention overcomes these problem by using a second material, which is preferably softer and/or more readily machined than chromium, to fill the grooves. This second material is machined (e.g. ground) to provide a smooth surface onto which a metal (e.g. chromium) layer or layers can be readily deposited. The present invention thus has the advantage over processes of the type described in GB2096421 of not requiring a step of grinding a layer of chromium nor of having to deposit a layer of chromium that is sufficiently thick to fill grooves in a rod and to also provide a suitably thick protective layer after it has been ground smooth.

In addition, the mask based etching technique of the present invention allows almost any required groove pattern to be formed in the encoder scale member. In particular, such an process allows the formation of complicated (e.g. multi-level) groove structures to encode absolute position information. The present invention can thus provide a more complex groove structure (e.g. for encoding absolute position) than would be possible using techniques of the type described in US2007/0214952 in which various coating(s) are applied over the entire surface of a rod that has been ground to provide a sinusoidal groove structure.

Advantageously, step (a) comprises the step of depositing a layer of resist on to the outer surface of the (blank) encoder scale member to form the mask. The resist may be any suitable material. For example, the resist may comprise a metal (e.g. an inert metal such as gold), a polymer or epoxy etc. Step (a) preferably also comprises patterning the deposited layer of resist (e.g. by removing parts of the resist layer using a laser) to provide the mask defining the required groove pattern. An etching step (b) may then be performed to etch or remove material from the blank encoder scale member through the mask thereby forming the required pattern of grooves. The etching step may comprise, for example, optical, chemical or plasma etching. Advantageously, a chemical etching step (e.g. a spray etch) is performed.

Conveniently, step (c) comprises filling the etched grooves with second material though the (e.g. resist) mask. An electro-plating technique may advantageously be used to deposit the material within the grooves. It is preferred that the depth of second material that is deposited is greater than the depth of the grooves of the rod. This ensures that the grooves are completely filled or slightly overfilled and ensures that a smooth surface can be provided during the machining process of step (d). Advantageously, no second material is deposited in the region between the grooves during step (c).

Advantageously, a step is performed between steps (c) and (d) of removing some or all of the mask from the encoder scale member. For example, a resist mask may be chemically washed off the encoder scale member. The mask, or part of that mask, may also or alternatively be removed during the machining step (d) along with the excess second material. Advantageously, no (or only minimal amounts of) second material remains in the regions between the grooves after the machining step.

As outlined above, the first material of the encoder scale member has a different magnetic permeability than the second material which fills the grooves in the encoder scale member. The first and second materials may be non-magnetic and magnetic respectively, or vice versa. For example, a non-magnetic (e.g. stainless steel) encoder scale member may include grooves filled with a second (magnetic) material. In such an example, the second material may comprise any magnetic metal. The second material may also comprise a carrier material (e.g. a polymer or epoxy) that includes particles of material having a high magnetic permeability (e.g. a high permeability metal dust).

Preferably, the first material (of the encoder scale member) is magnetic or has a high magnetic permeability. Conveniently, the first material comprises steel (which is magnetic). Steel is preferred as, for example, it has the mechanical strength required for the majority of hydraulic cylinder applications and is already commonly used to form piston rods. Conveniently, the second material (for filling the grooves) is substantially non-magnetic or has a low magnetic permeability. The second material may comprise an epoxy, polymer or any other suitable material. Advantageously, the second material is a metal. Preferably, the second material comprises at least one of tin, zinc and copper.

Advantageously, the encoder scale member is in the form of a rod. Preferably, the rod has a substantially circular cross-section. The rod may be solid or have a hollow core. The rod may be suitable for inclusion as a piston rod in hydraulic and/or pneumatic applications. The grooves may extend completely, or partially, around the rod. Advantageously, the grooves runs circumferentially around the rod. In other words, each groove is conveniently located in a radial plane; the radial plane being a plane perpendicular to the longitudinal axis of the rod. This arrangement removes the need to ensure the piston rod maintains a certain radial orientation relative to the magnetic sensor; i.e. rotation of the piston rod does not then affect position measurements.

The grooves of the encoder scale member may be of any required depth, width, spacing or shape. The grooves may all be identical or may take a plurality of different shapes. The grooves may be regularly spaced along the encoder scale member. Advantageously, the grooves formed in step (b) encode a pattern that provides a measure of absolute position. For example, the grooves may be provided to define bits (e.g. binary data bits) of an appropriate coded pattern from which absolute position can be determined.

Preferably, the metal deposited in step (e) is hard and/or non-magnetic and/or inert. Advantageously, step (e) comprises depositing a layer of chromium. In such an example, step (e) provides a substantially smooth chromium surface. A further step of polishing the metal (e.g. chrome) layer deposited in step (e) may optionally be performed. Such a polishing step can further improve the smoothness and/or geometric form of the chromium finish.

According to a second aspect of the present invention, an encoder scale comprises; a member formed from a first material, the member having a plurality of grooves in its outer surface, a second material filling the grooves in the member, the second material having a different magnetic permeability than the first material, wherein the second material is not present in the regions between the grooves, and a metal coating that covers the member and filled grooves, wherein the metal coating provides the encoder scale with a substantially smooth outer surface.

The present invention also provides a piston rod for an hydraulic cylinder that comprises; a rod member formed from a first material, the rod member having a plurality of grooves in its outer surface, a second material filling the grooves in the rod member, the second material having a different magnetic permeability than the first material, wherein the second material is not present in the regions between the grooves, and a chromium coating that covers the rod member and filled grooves, wherein the chromium coating provides the piston rod with a substantially smooth outer surface.

According to a third aspect of the present invention, a method of making an encoder scale member comprises the steps of: (i) taking an encoder scale member formed from a first material, the encoder scale member having a plurality of grooves in its outer surface, (ii) depositing a second material on the encoder scale member to substantially fill the grooves, the second material having a different magnetic permeability than the first material, (iii) using a machining (e.g. grinding) process to remove any excess second material and thereby provide an encoder scale member having a substantially smooth outer surface, and (iv) coating the outer surface of the encoder scale member with metal, wherein step (ii) comprises depositing the second material only into the grooves and not on to regions of the encoder scale member between the grooves. Advantageously, the encoder scale member comprises a rod.

The invention will now be described, by way of example only, with reference to the accompanying drawings, in which;

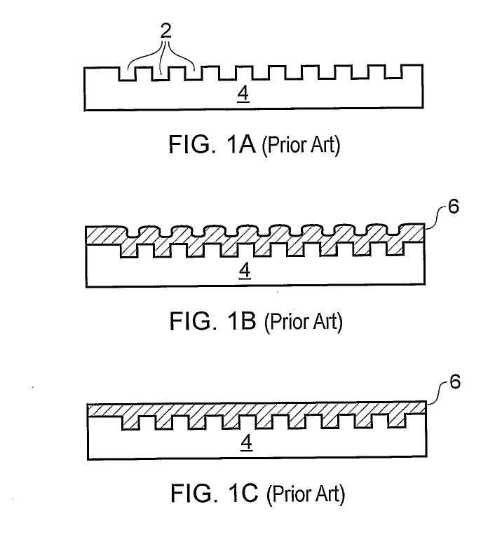

FIGS. 1A-1C show a prior art technique for forming a chromium plated piston rod,

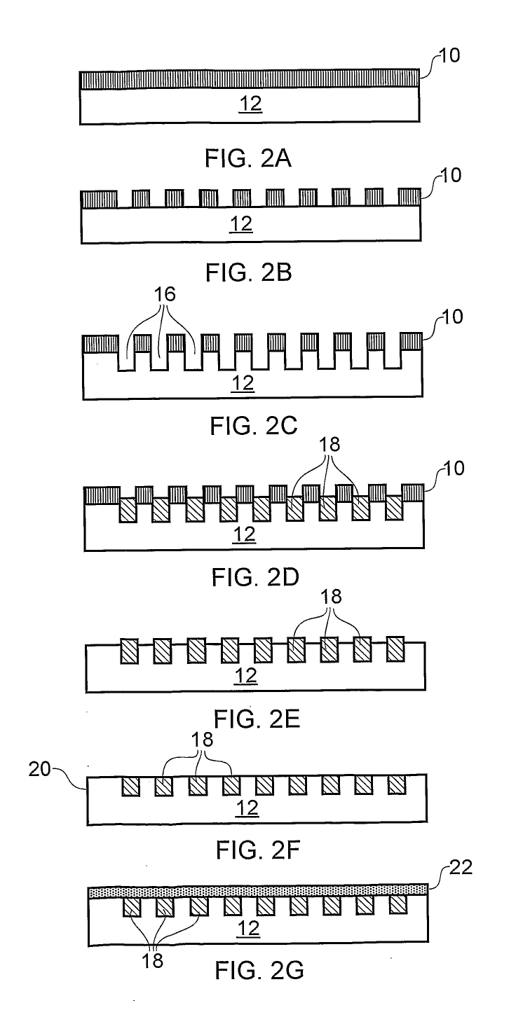

FIGS. 2A-2G shows a process according to the present invention for forming a chromium plated piston rod, and

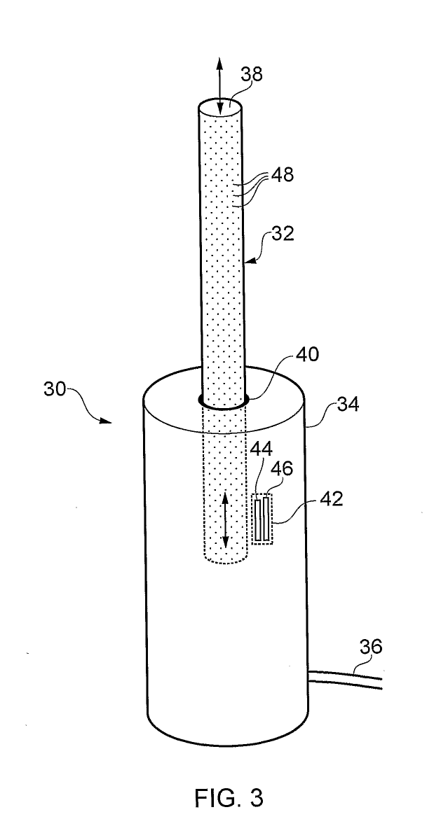

FIG. 3 shows a hydraulic cylinder incorporating a piston rod of the present invention.

Referring first to FIGS. 1A-1C, a prior art method of making a piston rod is illustrated. In particular, FIGS. 1A-C illustrate a prior art technique of the type described in GB2096421.

The first step of the prior art method is shown in FIG. 1A and comprises forming a series of grooves 2 in the surface 4 of a steel rod. As shown in FIG. 1B, the surface 4 of the steel rod is then coated with an outer layer of chromium 6 using a standard chrome electroplating deposition process. This chromium layer 6 fills the grooves 2 of the steel rod but has an undulating surface profile. The third step comprises grinding the chromium surface until the undulations are removed and a flat surface as shown in FIG. 1C is obtained.

This prior art method has the disadvantage that the tough outer layer of chrome has to be ground to remove the undulations resulting from the filling of the grooves. Grinding chrome, which is selected as the outer coating because it is a very hard material, is difficult.

Referring to FIGS. 2A to 2G, a method of the present invention will now be described. It should be noted that in FIGS. 2A to 2G a cross sectional view of a single surface of the rod is shown for clarity; the various layers and grooves illustrated would extend circumferentially around the rod in practice.

Step A of the method, which is illustrated in FIG. 2A, comprises depositing a layer of resist 10 onto the surface 12 of a steel rod. The resist may comprise a dry or liquid resist. A suitable resist would be, for example, a liquid resist formed from an acidic copolymer, adhesion promoter, carbon black and UV absorber in a 1-propanol solvent. This may be deposited to form a resist layer having a thickness of 2 μm or more.

Step B is then performed which involves patterning the resist layer 10 to form a mask as shown in FIG. 2B. The mask is provided by removing portions of the resist layer 10 to expose the parts of the surface 12 of the steel rod where it is wished to form grooves. This patterning step may be performed using a laser to selectively remove (ablate) parts of the resist layer 10.

In step C, the steel rod is chemically etched through the mask defined by the resist layer 10, thereby forming the required pattern of grooves 16 in the surface 12 of the rod as shown in FIG. 2C. A suitable chemical etchant is ferric chloride (FeCl₃) that can be applied by a spraying process. The etching process may be accurately controlled to provide the required groove depth. For example, grooves having a pitch of around 500 μm and a depth of 100-200 μm may be formed.

A step D is then performed in which copper 18 is deposited on the rod using an electroplating technique. The depth of copper 18 deposited is selected to more than fill the various grooves 16 formed in the surface 12 of the steel rod. As shown in FIG. 2D, the copper 18 thus overspills slightly from the grooves 16 within the surface 12. It should also be noted that the copper 18 is deposited mainly within the grooves and not on top of the layer of resist 10 because the resist is electrically insulating and hence does not tend to get coated in copper during the electroplating process.

FIG. 2E shows the copper standing proud of the rod surface 12 after an optional step E has been performed that comprises removing the remaining resist (e.g. using a suitable solvent). A step F can then be performed of grinding the surface of the rod to remove the excess copper (and any remaining resist) and thus providing a smooth outer surface 20 as shown in FIG. 2F. Copper, being a relatively soft metal compared with chromium, can be easily ground to provide the necessary smooth surface finish. Although grinding is described, any suitable machining process (e.g. broaching etc) may be used.

A layer of chromium 22 can then be deposited on the smooth outer surface 20 of the rod as shown in FIG. 2G. An optional step of depositing a layer of nickel may be performed prior to chromium deposition in order to improve the adherence of the chromium layer 22 to the rod. This chromium layer 22 has a substantially smooth outer surface that is free from the undulations that are formed using the prior art method described with reference to FIG. 1. A step of grinding the chromium is unnecessary, although an optional chromium polishing or buffing step may be performed if required. Although Chromium is described in this example, any suitably hard, preferably non-magnetic, metal may be used.

The piston rod formed using the above described process has a substantially smooth chromium surface and underlying regions of copper located in the grooves of the steel rod. Steel is a magnetic material whilst copper and chromium are both non-magnetic materials. The magnetic properties of the piston rod thus vary along its length in a manner that can be detected using a magnetic sensor arrangement of the type described below with reference to FIG. 3. It should be remembered that the use of a grooved steel rod is merely one example; rods formed of other materials may be used. In addition, metals other than copper (e.g. other soft, non-magnetic, metals such as tin or zinc) may be used to fill the grooves in the rod. Non-metallic materials (e.g. epoxy, polymers etc) may also be used to infill the grooves. The material of the rod and the material filling the grooves in the rod should, however, preferably have a different magnetic permeability such that an associated magnetic sensor element can measure the position and/or movement of the piston rod by sensing the resulting variations in magnetic field strength associated with the piston rod.

The groove pattern described above is substantially regular and repeating along the length of the piston rod. A piston rod of this type could thus be used with a so-called incremental magnetic sensor of known type that measures the amount of relative (or incremental) movement between the sensor and the piston rod. Alternatively, the grooves could be spaced in an irregular pattern to define a series of codewords (e.g. binary codewords) along the piston rod. Different depth and/or width grooves may also be provided to encode data bits. A multiple element sensor arrangement of known type could then be used to simultaneously read a plurality of such codewords thereby allowing absolute position to be measured. It can thus be seen that the method of the present invention can be used to form or encode a magnetic scale pattern of any required form into a piston rod.

Referring to FIG. 3, a hydraulic cylinder 30 is shown that incorporates a piston rod 32 manufactured using the method described above with reference to FIGS. 2A to 2G. The piston rod 32 is slideable within a pressurised cylinder casing 34. A supply of hydraulic fluid can be pumped into and out of the casing 34 via a fluid supply pipe 36 therefore causing the end 38 of the piston to advance and retract relative to the casing 34. A fluid seal 40 is provided on the casing 34 to engage the smooth chrome surface of the piston rod 32 to prevent leakage of hydraulic fluid. Although a hydraulic cylinder is shown, the piston rod may also be used in other (e.g. pneumatic) piston type arrangements or the like.

A magnetic sensor device 42 is placed at a fixed location within the casing 34 adjacent the piston rod 32. The sensor device 42 comprises a permanent magnet 46 and a plurality of appropriately spaced magnetic field sensor elements (e.g. Hall sensors) 44 disposed between the magnet 46 and the piston rod 32. As explained above, the piston rod comprises a series of grooves within a steel (magnetic) rod that contain copper (a non-magnetic material); the location of these grooves is illustrated by the dashed lines 48 in FIG. 3, although it should be noted that such grooves are covered by a chromium layer and are not externally visible. The magnetic field sensor elements 44 are, however, subjected to a different strength of magnetic field when adjacent a buried region of copper compared to a region of steel. The output signals from the sensor elements 44 can thus be combined in a known manner to allow movement of the piston rod 32 relative to the casing 34 to be measured.

As mentioned above, a more complex pattern of grooves may be used to encode a scale pattern that comprises a series of bits that form position related code words. An absolute position sensor device (e.g. comprising enough sensor elements to measure multiple bits of a codeword in parallel) may then be used to determine absolute piston rod position information relative to the casing.

It should be noted that although forming an encoder scale in the form of a piston rod is described in detail above, the technique of the present invention can be applied to substrates of any shape. For example, the invention may also be applied to encoder scale members in the form of flat or planar substrates.

1. A method of making an encoder scale, comprising the steps of:
(a) providing a mask defining a required groove pattern on an encoder scale member that is formed from a first material,
(b) etching material from the encoder scale member, through the mask, to form a plurality of grooves in the outer surface of the encoder scale member,
(c) depositing a second material on to the encoder scale member to substantially fill the grooves, the second material having a different magnetic permeability than the first material,
(d) using a machining process to remove any excess second material and thereby provide an encoder scale member having a substantially smooth outer surface, and
(e) coating the outer surface of the encoder scale member with a metal.

2. A method according to claim 1, wherein step (a) comprises the step of depositing a layer of resist on to the outer surface of the encoder scale member.

3. A method according to claim 2, wherein step (a) comprises patterning the deposited layer of resist to provide the mask defining the required groove pattern.

4. A method according to claim 1, wherein step (c) comprises filling the etched grooves with second material though the mask.

5. A method according to claim 1, comprising a step between steps (c) and (d) of removing the mask from the encoder scale member.

6. A method according to claim 1, wherein the first material is magnetic.

7. A method according to claim 6, wherein the first material comprises steel.

8. A method according to claim 1, wherein the second material is substantially non-magnetic.

9. A method according to claim 8, wherein the second material comprises at least one of tin, zinc and copper.

10. A method according to claim 1, wherein the encoder scale member is in the form of a rod having a substantially circular cross-section.

11. A method according to claim 10, wherein each of the grooves formed in step (b) runs circumferentially around the rod.

12. A method according to claim 1, wherein the grooves formed in step (b) encode a pattern that provides a measure of absolute position.

13. A method according to claim 1, wherein step (e) comprises depositing a layer of chromium.

14. A method according to claim 1, comprising an additional step of polishing the metal layer deposited in step (e).

15. A encoder scale, comprising;
a member formed from a first material, the member having a plurality of grooves in its outer surface,
a second material filling the grooves in the member, the second material having a different magnetic permeability than the first material, wherein the second material is not present in the regions between the grooves, and
a metal coating that covers the member and filled grooves, wherein the metal coating provides the encoder scale with a substantially smooth outer surface.

16. A method of making an encoder scale member, comprising the steps of:
(i) taking an encoder scale member formed from a first material, the encoder scale member having a plurality of grooves in its outer surface,
(ii) depositing a second material on the encoder scale member to substantially fill the grooves, the second material having a different magnetic permeability than the first material,
(iii) using a machining process to remove any excess second material and thereby provide an encoder scale member having a substantially smooth outer surface, and
(iv) coating the outer surface of the encoder scale member with metal, wherein step (ii) comprises depositing the second material only into the grooves and not on to regions of the encoder scale member between the grooves.
